(19) United States
(12) Patent Application Publication
(10) Pub. No.: US 2005/0233072 A1
(43) Pub. Date: Oct. 20, 2005

(54) Method for producing coatings sticking discrete patterns on a substrate

(75) Inventors: Oskar Stephan, Hockenheim (DE); Christian Hubert Weidl, Mannheim (DE); Volker Frenz, Mainz-Kostheim (DE); Felix Christian Gorth, Ludwigshafen (DE); Martin Beck, Maxdorf (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: BASF AKTIENGESELLSCHAFT a German corporation, Ludwigshafen (DE)

(21) Appl. No.: 10/520,021

(22) PCT Filed: Jul. 3, 2003
(86) PCT No.: PCT/EP03/07105

§ 371 Date: Dec. 28, 2004

(30) Foreign Application Priority Data
Jul. 4, 2002 (DE) 102 30 121.2

(51) Int. Cl. C09J 5/00

(52) U.S. Cl. 427/207.1; 427/487; 427/256

(57) ABSTRACT

The invention relates to a method of producing discrete patterns of an adhesive coating on a substrate, comprising the following steps: (a) the substrate is moved continuously or discontinuously in a conveying direction, (b) in an application zone a low-viscosity polymerizable and/or crosslinkable precursor material of an adhesive material is applied two-dimensionally to the substrate through at least one opening of substantially slotlike configuration of at least one movable applicator, a pattern being produced by movement of the applicator relative to the substrate, (c) downstream of the application zone the applied precursor material is polymerized and/or crosslinked.

The invention relates to a method of producing discrete patterns of adhesive coatings on a substrate.

In the manufacture of hygiene articles worn on the body, such as self-adhesive infant diapers and incontinence diapers, the problem exists of applying a layer of an adhesive material in a defined, discrete pattern to a substrate.

In connection with hygiene articles attached to the human body, use is frequently made of adhesive materials based on what are known as hydrogels. These are hydrous gels based on hydrophilic, water-insoluble polymers which form a three-dimensional network. The adhesive layers further comprise hydrocolloids such as starch, modified starch, cellulose esters, plant gum or carboxypolymethylene and/or prepolymers, partly crosslinked polymers, polymer blends, branched polymers, and graft (co)polymers.

Adhesive layers of hydrogels are obtained by photopolymerizing solutions of appropriate precursor compounds, such as solutions of appropriate hydrophilic monomers or of appropriate noncrosslinked hydrophilic polymers, or mixtures thereof, in the presence of crosslinkers. A substrate is coated with a solution of the precursor compounds and the coat is photopolymerized or photocrosslinked by exposure to high-energy radiation or is polymerized or crosslinked by other appropriate methods. Patterns are punched in the desired form from the resulting substrate, which has been coated with an adhesive layer, and are used, for example, in the manufacture of the aforementioned hygiene articles.

The method is laborious and has the disadvantage that large quantities of offcuts are produced, which go to waste.

Pour-on methods of the type mentioned are described, for example, in F. W. v. Bach, T. Duda, Moderne Beschichtungsverfahren, Wiley-VCH Weinheim, Berlin, New York, 2000, or in K. W. Mertz, Praxishandbuch moderne Beschichtungen, Hanser, 2001. With the pour-on methods of the prior art it is not possible to apply low-viscosity liquids in discrete forms with clean edges.

It is an object of the present invention to provide a method of producing discrete patterns of an adhesive coating on a substrate, said method being economic and devoid of the disadvantages of the prior art.

We have found that this object is achieved by means of a method of producing discrete patterns of an adhesive coating on a substrate, comprising the following steps:
(a) the substrate is moved continuously or discontinuously in a conveying direction,
(b) in an application zone a low-viscosity polymerizable and/or crosslinkable precursor material of an adhesive material is applied two-dimensionally to the substrate through at least one substantially slotlike opening of at least one movable applicator, a pattern being produced by movement of the applicator relative to the substrate,
(c) downstream of the application zone the applied precursor material is polymerized and/or crosslinked.

Where appropriate, in a subsequent step,
(d) the polymerized and/or crosslinked material is aftertreated, enhanced and/or converted to the end-product form.

The low-viscosity precursor material is generally applied to the substrate in a layer thickness of from 0.3 to 5 mm, preferably from 0.5 to 2 mm.

With the known pour-on methods of the prior art, it has been possible to apply only very thin layers.

The substrate is moved continuously or discontinuously in a conveying direction. The substrate passes through an application zone and a polymerization and crosslinking zone. The substrate is usually in the form of a belt which is unwound upstream of the application zone from a belt roll and is rolled up again to a belt roll downstream of the polymerization and crosslinking zone, where appropriate following unison with a protective film. The method of the invention preferably comprises the coating of the substrate, the polymerizing and/or crosslinking of the coating, aftertreatment where appropriate by applying of one or more further components, lining with a protective film, and winding up of the film composite formed. Instead of unwinding and winding up again the material it is also possible to use festooning, sheets or other suitable methods for storing, transporting and distributing sheet-like material

In one embodiment of the invention, the applicator, of which there is at least one, is moved in the substrate plane by means of a robot arm which is fully movable at least in the substrate plane but usually in all three spatial directions, and the patterns are produced by the movement of the robot arm relative to the substrate during the application of the low-viscosity precursor material. In the course of application the substrate may be moved further in the conveying direction, since the robot arm can be programmed such that its movement compensates the movement of the substrate.

In one preferred embodiment of the invention said at least one applicator is moved along a translation means at an angle to the conveying direction of the substrate. The coating patterns are therefore produced by the movement of the substrate in the conveying direction and by the movement of the applicator transversally in relation to said direction. The translation means is appropriately disposed perpendicularly to the conveying direction and the movement of said at least one applicator takes place perpendicularly to the conveying direction of the substrate, although it is also quite possible to dispose the translation means at an angle other than 90°.

With particular preference, the translation means is provided with two applicators which can be moved separately along the translation means. In this way it is possible to produce self-contained patterns: for example, by moving the applicators apart and together, annularly self-contained patterns, such as circular or oval patterns.

It is also possible to produce annularly self-contained patterns with only one applicator movable along a translation means. This can be done by moving the substrate first in the conveying direction during the application process, to produce part of the pattern, and then completing the pattern by briefly reversing the direction of movement of the substrate.

The polymerizable and/or crosslinkable low-viscosity precursor material is applied two-dimensionally to the substrate; in other words, the applied thickness of the layer is small relative to the applied width of the layer. The applied width can be varied by inclining the slotlike opening of the applicator.

The applied width of the layer is preferably from 3 to 50 mm.

The movable applicator used in the method of the invention is very substantially miniaturizable. Its dimensions are limited only by the size of the available die technology.

Downstream of the application zone the patternwise-applied polymerizable and/or crosslinkable precursor material is polymerized and/or crosslinked, thereby finally giving a patternwise adhesive coating. The precursor material is preferably photopolymerizable and/or radiation-crosslinkable. Photopolymerization and/or radiation crosslinking can be brought about by exposure to high-energy radiation, such as with electron beams, preferably with UV radiation, and appropriate initiators may be present in the precursor material.

Photopolymerization and/or radiation crosslinking may be carried out in a special crosslinking atmosphere: for example, in a simple container with an entry slot and an exit slot for the substrate and with radiation-transparent windows, which is charged with an appropriate gas mixture. Examples of suitable gases are noble gases, nitrogen, carbon dioxide or oxygen gas mixtures which contain less oxygen than does air (lean air).

In one preferred embodiment of the invention the adhesive coating is formed from hydrogel-forming polymers. Hydrogel-forming polymers are, in particular, polymers of (co)polymerized hydrophilic monomers, graft (co)polymers of one or more hydrophilic monomers onto an appropriate graft base, comb polymers and polymer networks, crosslinked cellulose ethers or starch ethers, crosslinked carboxymethylcellulose, partially crosslinked polyalkylene oxide, or natural products swellable in aqueous liquids, such as guar derivatives, alginates and carrageenans, for example.

Accordingly, the low-viscosity polymerizable or crosslinkable precursor material comprises corresponding polymerizable and/or crosslinkable monomers and/or polymers and crosslinkers which on crosslinking form hydrogel-forming crosslinked polymers, and appropriate initiators. The crosslinkable precursor material may further comprise hydrocolloids, plasticizers, polyols, carbohydrates, polyethers, polysaccharides, stabilizers, thickeners, rheology modifiers, antioxidants, UV stabilizers, skincare agents, antibacterial or bacteriostatic agents, fillers such as organic or inorganic colloids, pigments, water-soluble salt compounds, bentonites, silicates, titanium dioxide, nanoparticles, surfactants, preservatives, dyes, fragrances, and water.

Appropriate polymers may be of natural or synthetic origin. Examples are starch, cellulose or cellulose derivatives, and also other polysaccharides and oligosaccharides, polyvinyl alcohol, polyalkylene oxides, especially polyethylene oxides and polypropylene oxides, polyelectrolytes, polyethers, polyamines, polyamides, and hydrophilic polyesters. Suitable polyalkylene oxides, for example, have the formula 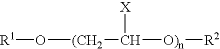
in which
R¹ and R² independently of one another are hydrogen, alkyl, alkenyl or acyl,
X is hydrogen or methyl, and
n is an integer from 1 to 10 000.

R¹ and R² are preferably hydrogen, C₁-C₄ alkyl, C₂-C₆ alkenyl or phenyl.

Preferred hydrogel-forming polymers are polymers containing acidic groups which are in the form of their salts, generally the alkali metal, alkaline earth metal or ammonium salts. Polymers of this kind swell particularly strongly on contact with aqueous liquids to form gels.

Preferred polymers are those obtained by crosslinking polymerization or copolymerization of acid-functional monoethylenically unsaturated monomers or their salts. It is also possible to (co)polymerize monomers without crosslinkers and then to crosslink them subsequently.

Examples of acid-functional monomers (monomers which carry acid groups) include monoethylenically unsaturated C₃ to C₂₅ carboxylic acids or anhydrides such as acrylic acid, methacrylic acid, ethacrylic acid, α-chloroacrylic acid, crotonic acid, maleic acid, maleic anhydride, itaconic acid, citraconic acid, mesaconic acid, glutaconic acid, aconitic acid and fumaric acid. Also suitable are monoethylenically unsaturated sulfonic or phosphonic acids and their salts, examples being vinylsulfonic acid, allylsulfonic acid, sulfoethyl (meth)acrylate, sulfomethyl acrylate, sulfopropyl acrylate, sulfopropyl methacrylate, 2-hydroxy-3-acryloyloxypropylsulfonic acid, 2-hydroxy-3-methacryloyloxypropylsulfonic acid, vinylphosphonic acid, allylphosphonic acid, styrenesulfonic acid, and 2-acrylamido-2-methylpropanesulfonic acid. The monomers may be used alone or in mixtures with one another.

Preferred monomers that may be present in the low-viscosity precursor material are acrylic acid, methacrylic acid, vinylsulfonic acid, acrylamidopropanesulfonic acid, and their derivatives and salts. Likewise suitable are mixtures of these acids and their salts, e.g., mixtures of acrylic acid and methacrylic acid, mixtures of acrylic acid and acrylamidopropanesulfonic acid, or mixtures of acrylic acid and vinylsulfonic acid.

For the purpose of optimizing properties of the adhesive coating the crosslinkable low-viscosity precursor material may comprise water-soluble or water-dispersible monomers and additional monoethylenically unsaturated compounds which do not carry any acid groups but which are copolymerizable with the acid-functional monomers. Examples include the amides and nitriles of monoethylenically unsaturated carboxylic acids, such as acrylamide, methacrylamide, and N-vinylformamide, N-vinylacetamide, N-methylvinylacetamide, acrylonitrile, and methacrylonitrile. Examples of other suitable compounds are vinyl esters of saturated C₁ to C₄ carboxylic acids such as vinyl formate, vinyl acetate or vinyl propionate, alkyl vinyl ethers having at least 2 carbon atoms in the alkyl group, such as ethyl vinyl ether or butyl vinyl ether, esters of monoethylenically unsaturated C₃ to C₆ carboxylic acids, e.g., esters of monohydric C₁ to C₁₈ alcohols and acrylic acid, methacrylic acid or maleic acid, monoesters of maleic acid, e.g., monomethyl maleate, N-vinyllactams such as N-vinylpyrrolidone or N-vinylcaprolactam, acrylic and methacrylic esters of alkoxylated monohydric saturated alcohols, e.g., of alcohols having from 10 to 25 carbon atoms, which have been reacted with from 2 to 200 mol of ethylene oxide and/or propylene oxide per mole of alcohol, and also monoacrylates and monomethacrylates of polyethylene glycol or polypropylene glycol, the molar masses (Mₙ) of the polyalkylene glycols possibly being, for example, up to 2000. Monomers possessing further suitability include styrene and alkyl-substituted styrenes such as ethylstyrene or tert-butylstyrene.

These non-acid-functional monomers may also be used in a mixture with other monomers, examples being mixtures of vinyl acetate and 2-hydroxyethyl acrylate in any proportions. These non-acid-functional monomers may be added to the low-viscosity precursor material in amounts of between 0 and 90% by weight, preferably less than 20% by weight.

Preferred hydrogel-forming crosslinked polymers are composed of 60-100% by weight acid-functional monoethylenically unsaturated monomers, which may have been converted into their alkali metal, alkaline earth metal or ammonium salts, and of 0-40% by weight, based on the overall weight of the monomers, of monoethylenically unsaturated monomers which do not carry acid groups.

Particular preference is given to crosslinked polymers of monoethylenically unsaturated C₃ to C₁₂ carboxylic acids and/or their alkali metal, alkaline earth metal or ammonium salts. In particular, crosslinked polyacrylic acids are preferred in which 10-100% of the acid groups are in the form alkali metal salts or ammonium salts.

Compounds able to function as crosslinkers are those containing at least two ethylenically unsaturated double bonds. Examples of compounds of this type are N,N′-methylenebisacrylamide, polyethylene glycol diacrylates and polyethylene glycol dimethacrylates, deriving in each case from polyethylene glycols with a molecular weight of from 106 to 8500, preferably from 400 to 2000, trimethylolpropane triacrylate, trimethylolpropane trimethacrylate, ethylene glycol diacrylate, ethylene glycol dimethacrylate, propylene glycol diacrylate, propylene glycol dimethacrylate, butanediol diacrylate, butanediol dimethacrylate, hexanediol diacrylate, hexanediol dimethacrylate, allyl methacrylate, diacrylates and dimethacrylates of block copolymers of ethylene oxide and propylene oxide, polyhydric alcohols, such as glycerol or pentaerythritol, esterified doubly or multiply with acrylic acid or methacrylic acid, triallylamine, dialkyldiallylammonium halides such as dimethyldiallylammonium chloride and diethyldiallylammonium chloride, tetraallylethylenediamine, divinylbenzene, diallyl phthalate, polyethylene glycol divinyl ethers of polyethylene glycols with a molecular weight of from 106 to 4000, trimethylolpropane diallyl ether, butanediol divinyl ether, pentaerythritol triallyl ether, reaction products of 1 mol of ethylene glycol diglycidyl ether or polyethylene glycol diglycidyl ether with 2 mol of pentaerythritol triallyl ether or allyl alcohol, and/or divinylethyleneurea. It is preferred to use water-soluble crosslinkers, such as N,N′-methylenebisacrylamide, polyethylene glycol diacrylates and polyethylene glycol dimethacrylates which derive from adducts of from 2 to 400 mol of ethylene oxide with 1 mol of a diol or a polyol, vinyl ethers of adducts of from 2 to 400 mol of ethylene oxide with 1 mol of a diol or polyol, ethylene glycol diacrylate, ethylene glycol dimethacrylate or triacrylates and trimethacrylates of adducts of from 6 to 20 mol of ethylene oxide with 1 mol of glycerol, pentaerythritol triallyl ether and/or divinylurea.

Further suitable crosslinkers include compounds containing at least one polymerizable ethylenically unsaturated group and at least one further functional group. The functional group of these crosslinkers must be capable of reacting with the functional groups, essentially the acid groups, of the monomers. Examples of suitable functional groups are hydroxyl, amino, epoxy, and aziridino groups. Use may be made, for example, of hydroxyalkyl esters of the abovementioned monoethylenically unsaturated carboxylic acids, e.g., 2-hydroxyethyl acrylate, hydroxyprolyl acrylate, hydroxybutyl acrylate, hydroxyethyl methacrylate, hydroxypropyl methacrylate, and hydroxybutyl methacrylate, allylpiperidinium bromide, N-vinylimidazoles such as N-vinylimidazole, 1-vinyl-2-methylimidazole, and N-vinylimidazolines such as 1-vinylimidazoline, 1-vinyl-2-methylimidazoline, 1-vinyl-2-ethylimidazoline or 1-vinyl-2-propylimidazoline, for example, which may be used in the form of the free bases, in quaternized form, or as a salt in the polymerization. Also suitable are dialkylaminoethyl acrylate, dimethylaminoethyl methacrylate, diethylaminoethyl acrylate, and diethylaminoethyl methacrylate. The basic esters are used preferably in quaternized or salt form. Additionally, glycidyl (meth)acrylate, for example, can be used.

Suitable crosslinker compounds further include those containing at least two functional groups which are capable of reacting with the functional groups, substantially the acid groups, of the monomers. The functional groups suitable for this purpose have already been mentioned above, i.e., hydroxyl, amino, epoxy, isocyanate, ester, amido, and aziridino groups. Examples of crosslinkers of this kind are ethylene glycol, diethylene glycol, triethylene glycol, tetraethylene glycol, polyethylene glycol, glycerol, polyglycerol, triethanolamine, propylene glycol, polypropylene glycol, block copolymers of ethylene oxide and propylene oxide, ethanolamine, sorbitan fatty acid esters, ethoxylated sorbitan fatty acid esters, trimethylolpropane, pentaerythritol, 1,3-butanediol, 1,4-butanediol, polyvinyl alcohol, sorbitol, starch, polyglycidyl ethers such as ethylene glycol diglycidyl ether, polyethylene glycol diglycidyl ethers, glycerol diglycidyl ether, glycerol polyglycidyl ethers, diglycerol polyglycidyl ethers, polyglycerol polyglycidyl ethers, sorbitol polyglycidyl ethers, pentaerythritol polyglycidyl ethers, propylene glycol diglycidyl ether and polypropylene glycol diglycidyl ethers, polyaziridine compounds such as 2,2-bishydroxymethylbutanol tris[3-(1-aziridinyl)propionate], 1,6-hexamethylenediethyleneurea, diphenylmethanebis-4,4′-N,N′-diethyleneurea, haloepoxy compounds such as epichlorohydrin and α-methylepifluorohydrin, polyisocyanates such as 2,4-tolylene diisocyanate and hexamethylene diisocyanate, alkylene carbonates such as 1,3-dioxolan-2-one and 4-methyl-1,3-dioxolane-2-one, and also bisoxazolines and oxazolidones, polyamidoamines and the reaction products thereof with epichlorohydrin, polyquaternary amines such as condensation products of dimethylamine with epichlorohydrin, homopolymers and copolymers of diallyldimethylammonium chloride and homopolymers and copolymers of dimethylaminoethyl (meth)acrylate, which where appropriate have been quaternized with—for example—methyl chloride.

Further suitable crosslinkers are polyvalent metal ions which are capable of forming ionic crosslinks. Examples of such crosslinkers are magnesium, calcium, barium, aluminum, chromium, titanium, and zirconium ions. These crosslinkers are used in the form, for example, of hydroxides, carbonates, or hydrogen carbonates. Further suitable crosslinkers are polyfunctional bases which are likewise capable of forming ionic crosslinks, examples being polyamines or their quaternized salts. Examples of polyamines are ethylenediamine, diethylenetriamine, triethylenetetramine, tetraethylenepentamine, pentaethylenehexamine, and polyethyleneimines, and also polyamines, with molar masses of in each case up to 4 000 000.

In the polymerizable and/or crosslinkable low-viscosity precursor material the crosslinkers are normally present in amounts of from 0.001 to 20% by weight and preferably from 0.01 to 5% by weight.

The photopolymerization and/or radiation crosslinking of the low-viscosity precursor material applied patternwise to the substrate, to give the adhesive coatings, may take place in the presence of an appropriate initiator. Initiators which can be used include all compounds which break down into free radicals on exposure to UV light or electron beams. They may, for example, include what are known as α cleavers, H-abstracting systems or else azides. Examples of such initiators are benzophenone derivatives such as Michler's ketone, phenanthrene derivatives, fluorene derivatives, anthraquinone derivatives, thioxanthone derivatives, coumarin derivatives, benzoin ethers and their derivatives, azo compounds such as the abovementioned free-radical initiators, substituted hexaarylbisimidazoles or acylphosphine oxides. Examples of azides are 2-(N,N-dimethylamino)ethyl 4-azidocinnamate, 2-(N,N-dimethylamino)ethyl 4-azidonaphthyl ketone, 2-(N,N-dimethylamino)ethyl 4-azidobenzoate, 5-azido-1-naphthyl 2-(N,N-dimethylamino)ethyl sulfone, N-(4-sulfonylazidophenyl)-maleimide, N-acetyl-4-sulfonylazidoaniline, 4-sulfonylazidoaniline, 4-azidoaniline, 4-azidophenacyl bromide, p-azidobenzoic acid, 2,6-bis(p-azidobenzylidene)cyclohexanone and 2,6-bis(p-azidobenzylidene)-4-methylcyclohexanone. The photoinitiators are used customarily in amounts of from 0.001 to 5% by weight, based on the monomers to be polymerized.

Suitable UV crosslinkers are, generally, all molecules which on exposure to UV light initiate a crosslinking reaction. Further examples are vinyl ethers, vinylcaprolactam, and Laromer® grades such as Laromer® TMPTA, Laromer® BDDA, Laromer® HDDA, Laromer® TPGDA, Laromer® DPGDA, Laromer® UR8837, and Laromer® TBCH.

The polymerizable and/or crosslinkable low-viscosity precursor material normally further comprises one or more plasticizers. Suitable plasticizers are water, alcohols, polyols such as glycerol or sorbitol, glycols and glycol ethers such as polyalkylene glycol monoethers or diethers, polyalkylene glycol monoesters or diesters, glycolates, glycerol esters and sorbitan esters, tartaric or citric esters, amphoteric surfactants derived from imidazolines, lactams, amides, polyamides, quaternary ammonium compounds, condensation products of polyethyleneimine and epichlorohydrin, phthalates, adipates, stearates, palmitates, sebacates, and myristates, and also natural or synthetic oils such as vegetable oils or mineral oils.

Preferred plasticizers are polyols, polyethylene glycol, glycerol, sorbitol, polysaccharides, polyvinyl alcohol, water, and mixtures thereof.

The plasticizers are normally present in amounts of from 5 to 75% by weight, based on the sum of all of the components present in the radiation-crosslinkable low-viscosity precursor material.

The low-viscosity precursor material may further comprise hydrocolloids such as starch, modified starch such as dextrin, cellulose esters such as carboxymethylcellulose, vegetable gums such as pectin karaya, gelatin, guar gum, gum arabic, locust bean gum or carboxypolymethylene.

The low-viscosity polymerizable and/or crosslinkable precursor material normally has a viscosity of between 50 and 10000 mPas, preferably between 50 and 1000 mPas.

Suitable substrates to which the polymerizable and/or crosslinkable low-viscosity precursor material is applied are PU foams, nonwoven materials such as polyethylene/polypropylene nonwovens, paper, textiles, nonwovens according to ISO 9092/EN 29092, metal foils or plastic films.

One exemplary embodiment of the invention is elucidated in more detail below with reference to the drawings, in which

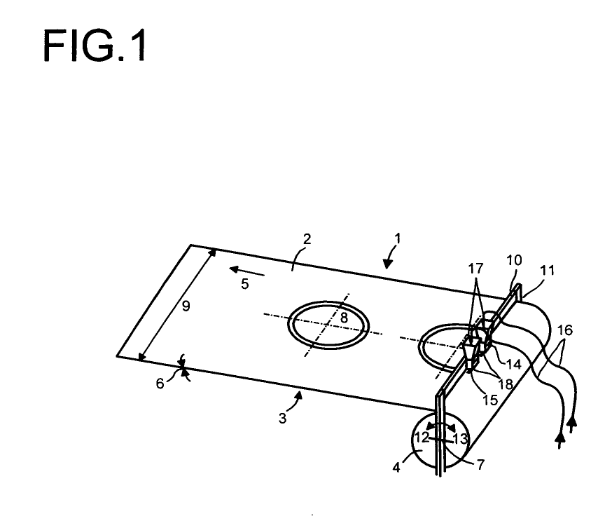

FIG. 1 shows a sketch of a device for applying a low-viscosity radiation-crosslinkable precursor material to a substrate in web form, and

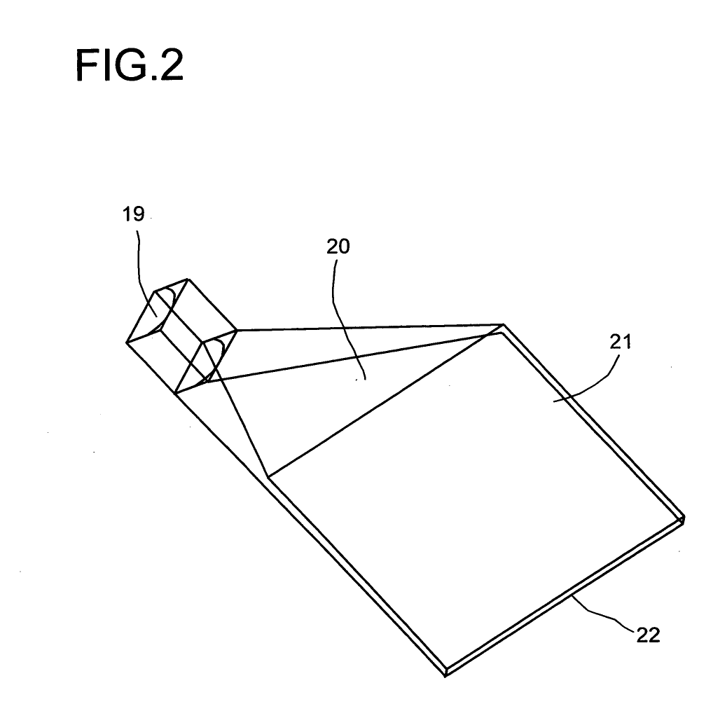

FIG. 2 shows one half of an applicator with a slot-like opening.

The device 1 shown in FIG. 1 for applying a low-viscosity radiation-crosslinkable precursor material to a substrate in web form is composed essentially of a translation means 10 on a support 11 with first and second applicators 14 and 15, movable along the translation means, having hoppers 17 and supply lines 16. During operation of the device, the hoppers 17 of the applicators 14 and 15 are fed through the supply lines 16 with the low-viscosity polymerizable and/or crosslinkable material, the feed being regulated by valves (not shown). A substrate 2 is unwound from a substrate stock roll 4 which is mounted rotatably on an axis 7 below the applicators 14 and 15 and which is rotatable in a first and a second rotary direction, 12 and 13 respectively, and the substrate 2 is thereby moved in the conveying direction 5. The substrate 2, with a substrate thickness 6 and a substrate width 9, has a top face 1 and a bottom face 3. The applicators 14 and 15 each apply (19) low-viscosity radiation-crosslinkable precursor material to the top face 1 of the substrate 2. As a result of the applicators 14 and 15 being moved apart and together along the translation means 10 during the movement of the substrate 2 in the conveying direction 5, the material is applied in freely selectable, discrete open or self-contained patterns 8 on the substrate 2.

The applicator shown in FIG. 2 has a feed 19, a distribution chamber 20, a supply slot 21 and an exit opening 22.

List of Parts

1 top face
2 substrate
3 bottom face
4 substrate stock roll
5 conveying direction
6 substrate thickness
7 axis of rotation
8 discrete pattern
9 substrate width
10 translation means
11 support
12 first rotary direction
13 second rotary direction
14 first applicator
15 second applicator
16 supply line
17 hopper
18 application of material
19 feed
20 distribution chamber
21 supply slot
22 exit opening

1. A method of producing discrete patterns of an adhesive coating on a substrate, comprising the steps:
(a) the substrate is moved continuously or discontinuously in a conveying direction,
(b) in an application zone, a low-viscosity polymerizable and/or crosslinkable precursor material of an adhesive material is applied two-dimensionally to the substrate through at least one opening of a substantially slotlike configuration of at least one movable applicator, a pattern being produced by movement of the applicator relative to the substrate, and
(c) downstream of the application zone, the applied precursor material is polymerized and/or crosslinked.

2. The method of claim 1 wherein the low-viscosity precursor material is applied in a layer thickness of from 0.3 to 5 mm to the substrate.

3. The method of claim 1 wherein the low-viscosity precursor material is applied in an applied width of from 3 to 50 mm to the substrate.

4. The method of claim 1 wherein the low-viscosity precursor material has a viscosity of between 50 and 10 000 mPas.

5. The method of claim 1 wherein said at least one applicator is moved by means of a robot arm which is freely movable in the substrate plane.

6. The method of claim 1 wherein said at least one applicator is moved along a translation means at an angle to the conveying direction of the substrate.

7. The method of claim 6, wherein the applicator is moved perpendicularly to the conveying direction of the substrate.

8. The method of claim 6 wherein self-contained patterns are produced with two applicators.

9. The method of claim 1 wherein the low-viscosity precursor material is photopolymerizable and/or radiation-crosslinkable.

10. The method of claim 7 wherein self-contained patterns are produced by two applicators.
